(19) United States
(12) Patent Application Publication
(10) Pub. No.: US 2021/0150054 A1
(43) Pub. Date: May 20, 2021

(54) SYSTEM AND METHOD FOR RECORDING INDEPENDENTLY VERIFIABLE USER CONSENT FOR DATA PROCESSING

(71) Applicant: Brett Circe, Fort Lauderdale, FL (US)

(72) Inventor: Brett Circe, Fort Lauderdale, FL (US)

(21) Appl. No.: 17/100,770

(22) Filed: Nov. 20, 2020

Related U.S. Application Data
(60) Provisional application No. 62/937,841, filed on Nov. 20, 2019.

(51) Int. Cl. G06F 21/62; G06F 21/60; H04L 9/06

(52) U.S. Cl. CPC G06F 21/6245; H04L 2209/38; H04L 9/0643; G06F 21/602

(57) ABSTRACT

A system and method for recording independently verifiable user consent for data processing. When processing an opt-in command from a user which signifies the user's consent to have their data processed, or an opt-out command from a user which signifies the user's withdrawal of consent (or otherwise refusal to provide their consent) to have their data processed, the system and method operates to verify the identity of the user, log the desired command in a private distributed ledger, and the synchronize the private distributed ledger with an open distributed ledger so as to be verifiable and auditable. In this regard, the system and method utilizes a parallel private ledger as an intermediary to the open distributed ledger to allow for more efficient and secure updating through synchronization.

### CROSS REFERENCE TO RELATED APPLICATIONS

This application claims the benefit of and incorporates by reference co-pending U.S. provisional patent application Ser. No. 62/937,841 filed Nov. 20, 2019.

### BACKGROUND OF THE INVENTION

### Field of the Invention

The present disclosure relates to secure and open recording of a user's consent to process the user's data.

### Description of the Prior Art

Direct marketing through newsletter mailings and email marketing is often a vital part of the operations of a business or enterprise. Email marketing in particular is widely considered as a cost effective way to communicate with a target audience to send advertisements or solicitations and/or to build loyalty or brand awareness.

As email marketing has grown, however, many jurisdictions have felt the need to enact regulation aimed at protecting the privacy and data rights of the recipients of email marketing. For example, the enactment of the General Data Protection Regulation (“GDPR”) in Europe has greatly increased the requirements for entities seeking to process a potential recipient individual's personal data for the purpose of sending emails to the individual. Pursuant to the GDRP, for any entity desiring the engage in email marketing directed to individuals in Europe, they must collect from any such individual affirmative consent that is freely given, specific, informed and unambiguous.

Thus, with the GDPR having gone into effect, it will be critical for entities desiring to utilize email marketing to be able to verify that they have consent from each of the individuals that they are sending their email marketing to. A problem which still exists, however, is that proving that someone opted into an email list with affirmative consent that is freely given, specific, informed and unambiguous can be very cumbersome or functionally impossible. While many existing processes could potentially be put in place to reduce the burden, such as double opt-in (also called verified opt-in) or confirmed opt-in, this is still not necessarily independently verifiable proof.

Accordingly, what is needed is a system and method for recording independently verifiable user consent for data processing which logs all opt-ins to an open distributed ledger so as to be verifiable and auditable. It would be advantageous for such a system and method for recording independently verifiable user consent for data processing to additionally operate a private ledger in parallel with the open distributed ledger to allow for more efficient and secure updating through synchronization.

### SUMMARY OF THE INVENTION

A method for recording independently verifiable user consent for data processing, comprising the steps of: receiving by a recordation server a consent package associated with at least one subscribing user, wherein the consent package includes data related to a provision or withdrawal of consent by the at least one subscribing user for at least one of gathering, processing and use of personal data; causing the at least one subscribing user's identity to be verified; compiling by the recordation server a recordation payload relating to at least the consent package; recording at least the recordation payload on a first distributed digital ledger; and following the step of recording, synchronizing the first distributed digital ledger with a second distributed digital ledger such that the at least one transaction on the first distributed digital ledger is reflected on the second distributed digital ledger, wherein the second distributed digital ledger has no access restrictions.

### BRIEF DESCRIPTION OF THE DRAWINGS

FIG. 1 is a block diagram of the data flow between the components of a system for recording independently verifiable user consent for data processing in accordance with the present disclosure.

FIG. 2 shows the process though which a method for recording independently verifiable user consent for data processing performs a subscribe procedure or an unsubscribe procedure in accordance with the present disclosure.

### DETAILED DESCRIPTION OF THE INVENTION

Described herein is a system and method for recording independently verifiable user consent for data processing, which may include gathering, processing and use of personal data by a processing entity. When processing an opt-in command from a user which signifies the user's consent to have their data processed, which for the present disclosure may define consent to receive email marketing to the user's email address, the system and method for recording independently verifiable user consent for data processing operates to log such an opt-in to an open distributed ledger so as to be verifiable and auditable. Similarly, when processing an opt-out command from a user which signifies the user's withdrawal of consent (or otherwise refusal to provide their consent) to have their data processed in such a manner, the system and method for recording independently verifiable user consent for data processing operates to log such an opt-out the open, distributed ledger so as to be verifiable and auditable. As a part of the logging of opt-ins and opt-outs, the system and method for recording independently verifiable user consent for data processing utilizes a parallel private ledger as an intermediary to the open distributed ledger to allow for more efficient and secure updating through synchronization.

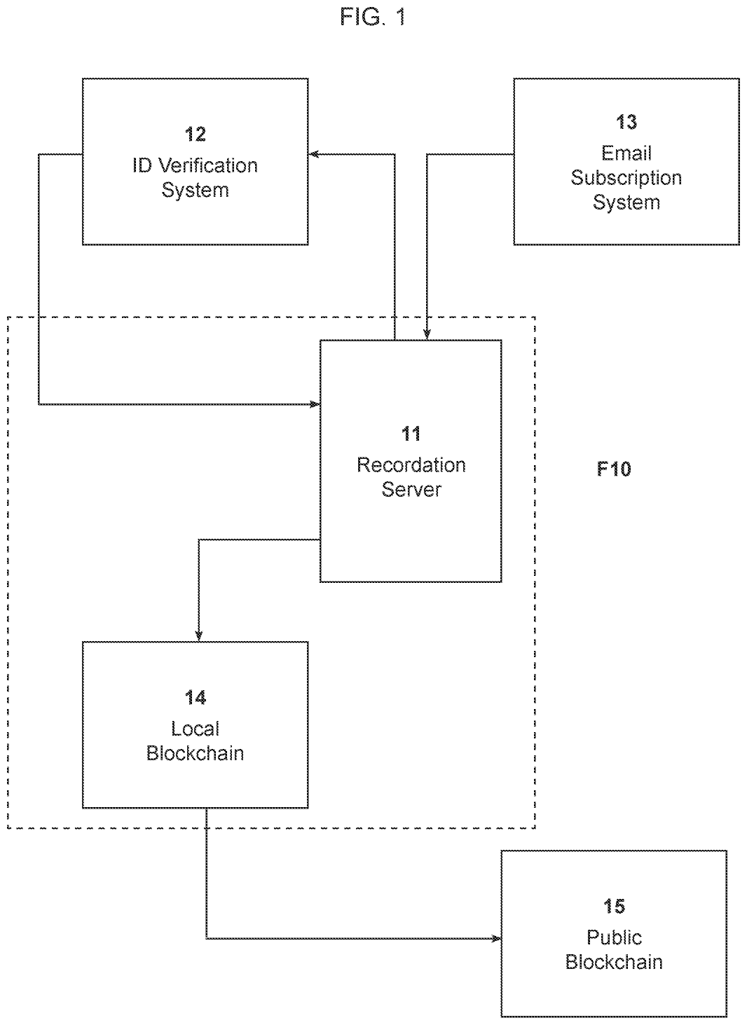

Referring now to the drawings and in particular FIG. 1, a system for recording independently verifiable user consent for data processing 10, and the method performed by said system, utilizes a recordation server 11 that is communicatively connected with an identification verification system 12 and a email subscription system 13 so as to receive data electronically from both the identification verification system 12 and email subscription system 13 as well as to send requests for data to at least the identification verification system 12 in response to data received from the email subscription system 13. The recordation server 11 is also operatively connected to a local blockchain 14 and a public blockchain 15 so as to be able to record transactions on the local blockchain 14 and cause the local blockchain 14 to synchronize with the public blockchain 15.

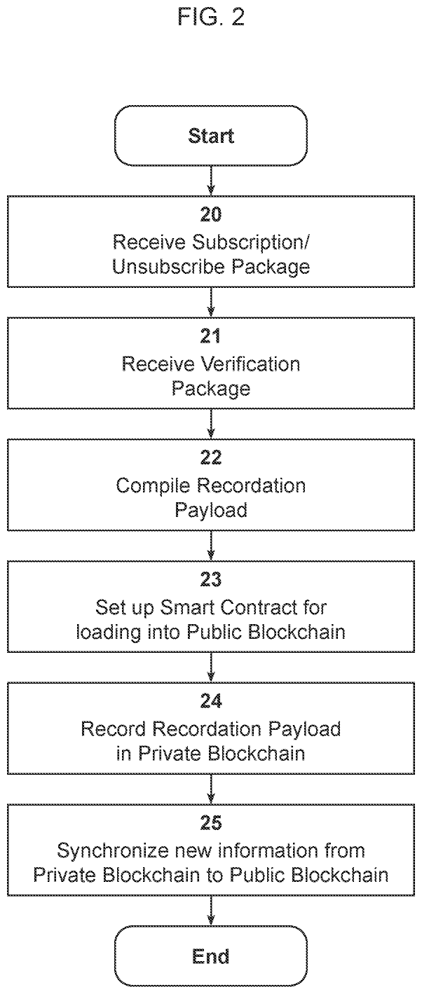

Referring now to FIG. 2, the system for recording independently verifiable user consent for data processing begins its performance of a subscribe procedure when the recordation server receives a subscription package from the email subscription system at step 20. It is contemplated that the subscription package may be generated by the email subscription system, and sent to the recordation system, when a subscribing user has completed an email subscription form (or otherwise provided information indicating that the subscribing user is providing consent to receive email marketing from the email subscription system). The subscription package may include an email address, Internet Protocol (“IP”) address, country, email list identifier, and email list frequency related to the subscribing user.

Following the receipt of a subscription package, the recordation server requests and receives a verification package from the identification verification system so as to independently verify the subscribing user's identity through a third party service at step 21. Embodiments of the system for recording independently verifiable user consent for data processing may utilize a secure identity platform such as that provided by Civic Technologies, Inc. The verification package may additionally provide to the recordation system a User Identity Code from the identification verification system.

With the subscription package and the verification package, the recordation server then compiles a recordation payload that includes an email address, User Identity Code, IP address, country, email list identifier, and email list frequency related to the subscribing user then hashes and encrypts the recordation payload at step 22. Once the recordation payload is created, the recordation server sets up a smart contract with the necessary information to load the recordation payload in the public blockchain at step 23. The recordation server then logs the recordation payload to the private blockchain at step 24. With the recordation payload logged into private blockchain, the recordation server then synchronizes new information from the local private blockchain with the public blockchain (e.g. Etherium) for public verification at step 25.

The subscribe procedure may additionally include a step of creating a reference link which provides direct access to the original subscription information, as logged in the private blockchain and/or the public blockchain.

Advantageously, because the information which defined the recordation payload is synchronized to the public blockchain, the public blockchain will contain all of the information needed to allow users to verify opt-in.

It is contemplated that even after synchronization, the private blockchain will store the information which defined the recordation payload locally for security purposes.

The system for recording independently verifiable user consent for data processing performs unsubscribe procedure in much of the same way as the subscribe procedure. The performance of the unsubscribe procedure begins when the recordation server receives an unsubscribe package from the email subscription system at step 20. It is contemplated that the unsubscribe package may be generated by the email subscription system, and sent to the recordation system, when an unsubscribing user has unsubscribed from an email list by clicking an unsubscribe link or filling out an unsubscribe form (or otherwise provided information indicating that the unsubscribing user is withdrawing consent to receive email marketing from the email subscription system). The unsubscribe package may include an IP address, country, email list identifier, and a reference link to the original subscription information related to the subscribing user.

Following the receipt of an unsubscribe package, the recordation server requests and receives a verification package from the identification verification system so as to independently verify the unsubscribing user's identity through a third party service at step 21. The verification package will additionally provide to the recordation system the User Identity Code associated with the unsubscribing user.

With the unsubscribe package and the verification package, the recordation server then compiles a recordation payload that includes the User Identity Code, IP address, country, email list identifier, and reference link to the original subscription information for the unsubscribing user then hashes and encrypts the recordation payload at step 22. In embodiments wherein a reference link to the original subscription information was not created at the time an original subscription was recorded, the recordation server may locate the original subscription using the User Identity Code and the email list identifier and create the link to the original subscription information immediately preceding step 22.

Once the recordation payload is created, the recordation server sets up a smart contract with the necessary information to load the recordation payload to the public blockchain at step 23. The recordation server then logs the recordation payload to the private blockchain at step 24. With the recordation payload logged into private blockchain, the recordation server then synchronizes new information from the local blockchain with the public blockchain (e.g. Etherium) for public verification at step 25.

As it does with the recordation of subscriptions, the public blockchain will contain all of the information needed to allow users to verify opt-out and the private blockchain will store the information which defined the recordation payload locally for security purposes. It is appreciated, however, that because the blockchain is immutable, the original subscription information cannot be removed. As a result, opt-out can be verified by being referenced in the un-subscription block (if it exists).

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for recording independently verifiable user consent for data processing, comprising the steps of:
receiving by a recordation server a consent package associated with at least one user, wherein the consent package includes data related to a provision or withdrawal of consent by the at least one user for at least one of gathering, processing and use of personal data;
causing the at least one user's identity to be verified;
compiling by the recordation server a recordation payload, wherein the recordation payload relates to information in at least the consent package;
recording at least the recordation payload on a first distributed digital ledger; and
following the step of recording, synchronizing the first distributed digital ledger with a second distributed digital ledger such that the at least one transaction on the first distributed digital ledger is reflected on the second distributed digital ledger, wherein the second distributed digital ledger has no access restrictions.

2. The method of claim 1, additionally comprising the step of receiving by the recordation server a verification package associated with the at least one user, wherein the step of receiving the verification package follows the step of causing the at least one user's identity to be verified and the verification package includes data related to an attestation of an identity of the at least one user.

3. The method of claim 2, wherein the recordation payload additionally relates to information in the verification package.

4. The method of claim 2, wherein the verification package includes a remotely generated code operative to validate the identity of the at least one user.

5. The method of claim 1, additionally comprising the step of creating a smart contract associated with the recordation payload which is suitable to be deployed in the first distributed ledger and the second distributed ledger.

6. The method of claim 1, wherein the consent package includes at least an identification of the personal data of the at least one user for which consent to process is being provided or withdrawn and at network address related to the at least one user.

7. The method of claim 1, wherein access to the first distributed digital ledger is restricted.

8. The method of claim 1, wherein access to the first distributed digital ledger is limited to the recordation server.

9. The method of claim 1, wherein the first distributed digital ledger is defined by a first blockchain having restricted access.

10. The method of claim 1, wherein the second distributed digital ledger is defined by a second blockchain.

11. A method for recording independently verifiable user consent for data processing, comprising the steps of:
receiving by a recordation server a consent package associated with at least one user, wherein the consent package includes data related to a provision or withdrawal of consent by the at least one user for at least one of gathering, processing and use of personal data;
causing the at least one user's identity to be verified;
following the step of causing the at least one user's identity to be verified, receiving by the recordation server a verification package associated with the at least one user, wherein the verification package includes data related to an attestation of an identity of the at least one user;
compiling by the recordation server a recordation payload, wherein the recordation payload relates to information in at least the consent package and the verification package;
creating a smart contract associated with the recordation payload which is suitable to be deployed in the first distributed ledger and the second distributed ledger;
recording at least the recordation payload on a first distributed digital ledger; and
following the step of recording, synchronizing the first distributed digital ledger with a second distributed digital ledger such that the at least one transaction on the first distributed digital ledger is reflected on the second distributed digital ledger, wherein access to the first distributed digital ledger is restricted and the second distributed digital ledger has no access restrictions.

12. The method of claim 11, wherein the verification package includes a remotely generated code operative to validate the identity of the at least one user.

13. The method of claim 1, additionally comprising the step of creating a smart contract associated with the recordation payload which is suitable to be deployed in the first distributed ledger and the second distributed ledger.

14. The method of claim 11, wherein the consent package includes at least an identification of the personal data of the at least one user for which consent to process is being provided or withdrawn and at network address related to the at least one user.

15. The method of claim 11, wherein access to the first distributed digital ledger is limited to the recordation server.

16. The method of claim 11, wherein the first distributed digital ledger is defined by a first blockchain.

17. The method of claim 11, wherein the second distributed digital ledger is defined by a second blockchain.

18. A method for recording independently verifiable user consent for data processing, comprising the steps of:
receiving by a recordation server a consent package associated with at least one user, wherein the consent package includes data related to a provision or withdrawal of consent by the at least one user for at least one of gathering, processing and use of personal data;
wherein the consent package includes at least an identification of the personal data of the at least one user for which consent to process is being provided or withdrawn and at network address related to the at least one user;
causing the at least one user's identity to be verified;
following the step of causing the at least one user's identity to be verified, receiving by the recordation server a verification package associated with the at least one user, wherein the verification package includes data related to an attestation of an identity of the at least one user;
compiling by the recordation server a recordation payload, wherein the recordation payload relates to information in at least the consent package and the verification package;
creating a smart contract associated with the recordation payload which is suitable to be deployed in the first distributed ledger and the second distributed ledger;
recording at least the recordation payload on a first distributed digital ledger; and
following the step of recording, synchronizing the first distributed digital ledger with a second distributed digital ledger such that the at least one transaction on the first distributed digital ledger is reflected on the second distributed digital ledger, wherein access to the first distributed digital ledger is restricted and the second distributed digital ledger has no access restrictions.

19. The method of claim 18, wherein the verification package includes a remotely generated code operative to validate the identity of the at least one user.

20. The method of claim 18, wherein access to the first distributed digital ledger is limited to the recordation server.
